(19) United States
(12) Patent Application Publication
(10) Pub. No.: US 2014/0214891 A1
(43) Pub. Date: Jul. 31, 2014

(54) HIERARCHICAL USER INTERFACE AND FUNCTIONAL APPARATUS

(71) Applicant: HADRONEX, INC., Escondido, CA (US)

(72) Inventors: Gregory M. Quist, Escondido, CA (US); David A. Drake, Escondido, CA (US); David Rees, Escondido, CA (US); Lawrence B. Merchell, Escondido, CA (US); Tim C. DeMarco, Escondido, CA (US); Justin H. Hobbs, Escondido, CA (US)

(73) Assignee: Hadronex, Inc., Escondido, CA (US)

(21) Appl. No.: 13/832,269

(22) Filed: Mar. 15, 2013

Related U.S. Application Data
(60) Provisional application No. 61/757,685, filed on Jan. 28, 2013.

(51) Int. Cl. G06F 17/30

(52) U.S. Cl. CPC G06F 17/30864
USPC 707/770

(57) ABSTRACT

A hierarchical data management tool and user interface that provides an efficient and effective means for an organization to organize both users and their access to a system consisting of a large number of remote sensing locations. Various levels of notifications for specified personnel allow the notified persons to respond to alerts in an efficient manner. Personnel can be hierarchically organized according to their qualifications and proximity to the sensing location/alert type.

### CROSS-REFERENCE TO RELATED APPLICATION(S)

This application claims the benefit of U.S. Provisional Patent Application No. 61/757,685, filed Jan. 28, 2013, the contents of which are hereby incorporated by reference in its entirety.

### BACKGROUND

1. Field

This invention relates remote distributed sensor management. More particularly, it relates to an hierarchical data management tool and user interface for a large number of remote sensing locations.

2. Background

Machine to machine (MTM) sensor networks used for widespread remote sensing are being developed and deployed for use by large organizations to: gain a real-time knowledge of the condition of their remote assets; prevent serious problems by receiving precursor data suggesting sub-optimal conditions; optimize their maintenance processes by providing service only when the remote real-time data suggest it; deferring expensive capital improvements through stretching the lifetime of assets by closely monitoring the conditions of the assets; and optimize overall system performance by noting stresses on various parts of the system from external events. A major concern of these organizations is how huge amounts of data from a large number of remotely monitored sites is efficiently and effectively disseminated to the members of the organization so that the appropriate responses to the data are taken.

In view of the above, there has been a long standing need in the sensor community for improved information dissemination and management tools, from a user perspective and from a sensor perspective. As described in the following, various systems and methods are detailed for addressing these and other concerns in the prior art.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, a method is provided comprising: electronically receiving device data transmitted from a remote measurement device; determining an occurrence of an event based on the received device data and one or more event rules; obtaining a plurality of remote measurement device parameters associated with the remote measurement device from a database containing a hierarchy of rule sets matching personnel data with remote measurement devices, physical resource data, notification states and access controls; querying the hierarchy for at least one or more persons assigned to the remote measurement device or to a geographical proxy thereof and also having a notification state corresponding to the event; electronically notifying information of the event to a communication device of the identified one or more persons; and responding to an input from the assigned person via the communication device to provide at least one of the remote measurement device location and access control.

In another aspect of the disclosed embodiments, a remote measurement device management and notification system is provided, comprising: means for electronically receiving device data transmitted from a remote measurement device; means for determining an occurrence of an event based on the received device data and one or more event rules; means for obtaining a plurality of remote measurement device parameters associated with the remote measurement device from a database containing a hierarchy of rule sets matching personnel data with remote measurement devices, physical resource data, notification states and access controls; means for querying the hierarchy for at least one or more persons assigned to the remote measurement device or to a geographical proxy thereof and also having a notification state corresponding to the event; means for electronically notifying information of the event to a communication device of the identified one or more persons; and means for responding to an input from the assigned person via the communication device to provide at least one of the remote measurement device location and access control.

In yet another aspect of the disclosed embodiments, a tangible computer-readable storage medium having instructions stored thereon is provided, that when executed by a processor cause the processor to: determining an occurrence of an event based on received device data and one or more event rules; obtaining a plurality of remote measurement device parameters associated with the remote measurement device from a database containing a hierarchy of rule sets matching personnel data with remote measurement devices, physical resource data, notification states and access controls; querying the hierarchy for at least one or more persons assigned to the remote measurement device or to a geographical proxy thereof and also having a notification state corresponding to the event; electronically notifying information of the event to a communication device of the identified one or more persons; and responding to an input from the assigned person via the communication device to provide at least one of the remote measurement device location and access control.

### BRIEF DESCRIPTION OF THE DRAWINGS

FIG. 1 is a schematic layout of a remote water level monitoring system.

FIG. 2 is a “component” illustration of a remote field unit.

FIG. 3 is an illustration of an overall system scheme.

FIG. 4 is a schematic example of one embodiment of a hierarchy scheme.

FIG. 5 illustrates an example of geographical divisions of the physical layout of monitoring locations.

FIG. 6 shows an example of personnel-based hierarchy structure with alarms and access controls.

FIG. 7 is a flow chart of one embodiment of implementing the hierarchy system.

FIG. 8 is an illustration of the hierarchy system in operation.

FIG. 9 shows an example of a multiple hierarchy structure with location hierarchy.

FIG. 10 shows one example of a multiple hierarchy with two hierarchies.

FIG. 11 is hardware diagram of a computer device.

### DETAILED DESCRIPTION

Methods and systems for an efficient and effective hierarchical data management tool and user interface are described, as a means to organize both users and their access to a system of a large number of remote sensing locations. For purposes of illustration, without limitation to other applications or uses of this invention, consider a wastewater utility that has tens of thousands of individual manholes, and hundreds or thousands of these manholes are being monitored for water levels via remote real-time sensing. Other examples include without limitation electrical utilities, water distribution systems, electrical grid networks, weather stations, and other widely dispersed sensor systems.

Water levels in the wastewater manholes are typically monitored using ultrasonic level sensors, capacitive contact sensors, RADAR, pressure sensors or flow meters as a limited set of examples. Other parameters may be monitored in these manholes as well, including without limitation: gases such as H₂S, CO, Cl₂, CH₄, O₂; hydrocarbons in the water; other water quality parameters, such as dissolved oxygen, pH, temperature, biological oxygen demand (BOD), total dissolved solids, etc.; other environmental parameters like temperature, humidity, dust, acoustics, etc. may also be monitored.

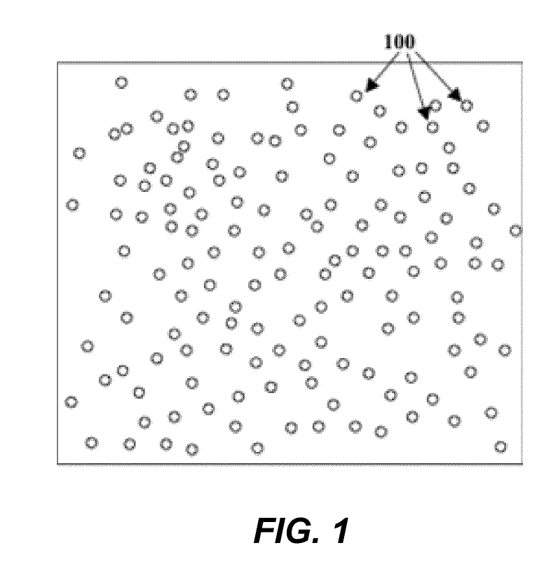

FIG. 1 shows a schematic layout of such a remote water level monitoring system in a municipality or other wastewater utility. Each individual dot 100 represents a single monitoring location with a remote field unit (RFU).

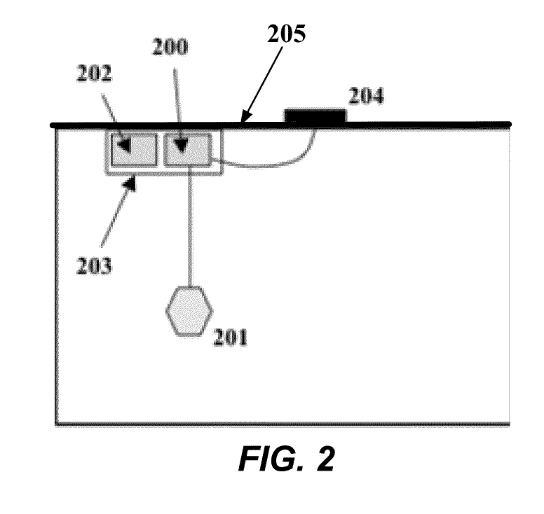

FIG. 2 is a “component” illustration of a RFU that has a transmit/receive wireless communications unit 200, a sensor 201, a power supply 202, a means 203 to mount the unit in or around the manhole 205. The wireless communications unit contains an antenna 204, a processor, a wireless radio, and supporting electronics, including a tangible computer-readable storage medium for storing instructions that when executed will cause the RFU to implement the functions as described herein. It is understood that FIG. 2 is not drawn to scale and various elements may be larger or smaller depending on design preference, as well as in arrangement.

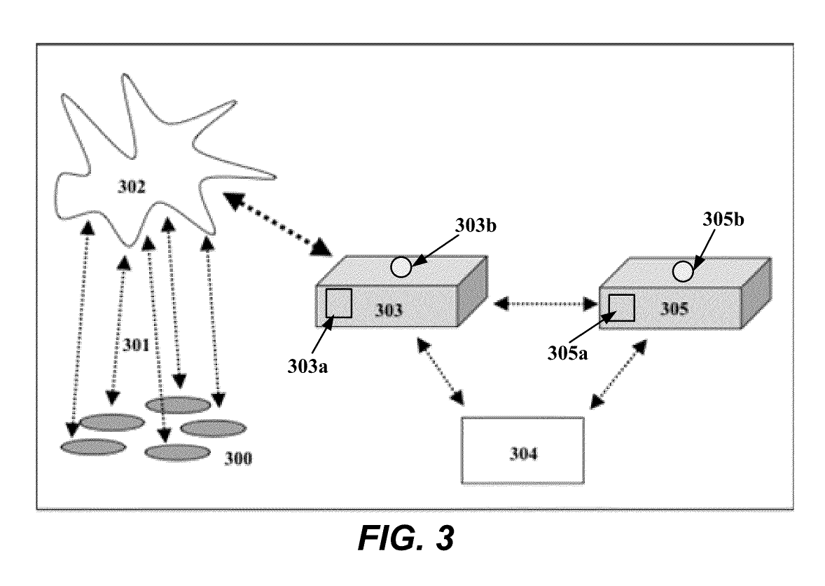

FIG. 3 shows an overall system scheme. Each RFU located within one or more monitoring locations 300 communicates via two-way data 301 through a wireless network 302 including but not limited to cell phone, dedicated two-way radio, paging networks, satellite networks, etc. Data from each RFU passes through wireless network 301 and server and/or other communications means 303 where it is processed and parsed to a user interface module 304 such as a computer, laptop, SmartPhone, or other graphical device that displays data. Alternatively, the data from server and/or communication means 303 may pass through another or many more servers or communications gateways 305 and then pass though to the user interface module 304. In some embodiments, this communications scheme is fully two way. Thus, since the RFU's collected measurement data is transmitted via a server and/or communication means 303 (and possibly though more servers and/or communications gateway 305), the collected measurement data can be processed by processor(s) 303a, 305a or stored in an electronic database 303b, 305b. Of course, user interface module 304 may also contain a processor(s)/storage capabilities, according to implementation preference.

Accordingly, as will be appreciated by one skilled in the art, the present disclosure and of the “computer” system of FIG. 3 may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, and the like. A given module may even be implemented such that the described functions are performed by separate processors and/or computing hardware platforms.

Referring again to FIG. 3, a software program resides either on server (and/or communications means) 303 or server(s) (and/or communications gateway) 305 or a combination thereof that enables the user through the user interface module 304 to develop an organizational scheme that represents each monitoring location as part of a hierarchy that provides the data to the appropriate persons. That is, each monitoring device, or RFU, may have one or more monitoring device hierarchy parameters associated with it. Transmissions from the RFU may include the measurement data as well as the assigned device hierarchy parameters. Alternatively, the RFU transmission may include identification parameters (e.g., and ID parameter, an IP address, a wireless identifier such as an cell-related IMEI, IMSI, TMSI identifier, or the like), and the server may retrieve the associated monitoring device hierarchy parameters from the electronic database device. The servers (and/or communications means/gateways) 303 and 305 contain processors 303a, 305a and data storage devices 303b, 305b that are readable or accessed by the processors 303a, 305a. These data storage devices 303a, 305b may be disk drives, or computer memory devices such as solid state media, as non-limiting examples.

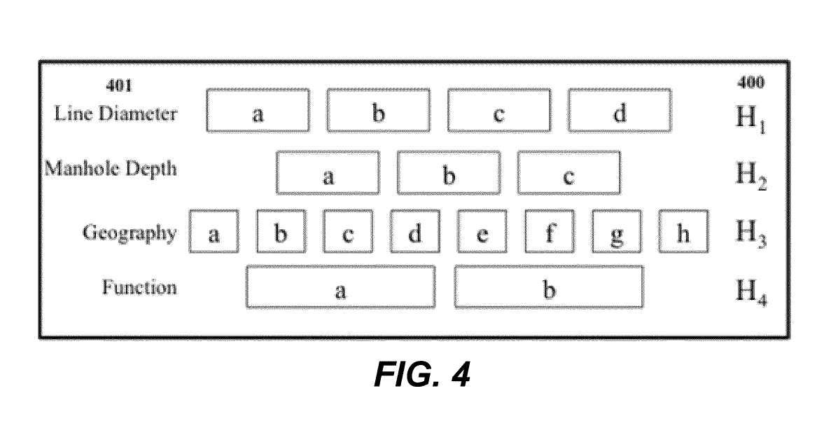

FIG. 4 shows schematically an example of one embodiment of a hierarchy scheme. While the number of hierarchy levels is not limited, for purposes of illustration here, the number of hierarchy levels is set at four (4). The four hierarchy levels 400 (H1, H2, H3, and H4) correspond to various classifications of monitoring sites 401. The number of hierarchies and the number of classifications inside each hierarchy, “a” through “h” for example, are meant to be illustrative and not limiting to the numbers of each. In this embodiment, a given monitoring device may be associated with one or more labels (e.g., Line Diameter, Manhole Depth, etc.) from each level of the hierarchy to thereby make up the monitoring device hierarchy parameters.

Another function of the hierarchy structure presented by the user interface module is to select or de-select particular locations or RTUs, for user display, user commands, user targeted alarms, and other user operations, including visual data display, such as on a map. Thus, in this example, a user may select all monitoring devices in a given geographic region, or all monitoring devices that provide a certain function (or functions), or combinations thereof, such as all monitoring devices that provide function “a” in geographic regions “a,” “c,” or “e,” that have a manhole depth of “c” and a line diameter of “a” or “d”. The server may then render the locations of the selected remote monitoring devices on a map, and may also provide status information adjacent to the location, and may also include color coded information relating to status, such as recent alarms, alerts, or upcoming maintenance requirements.

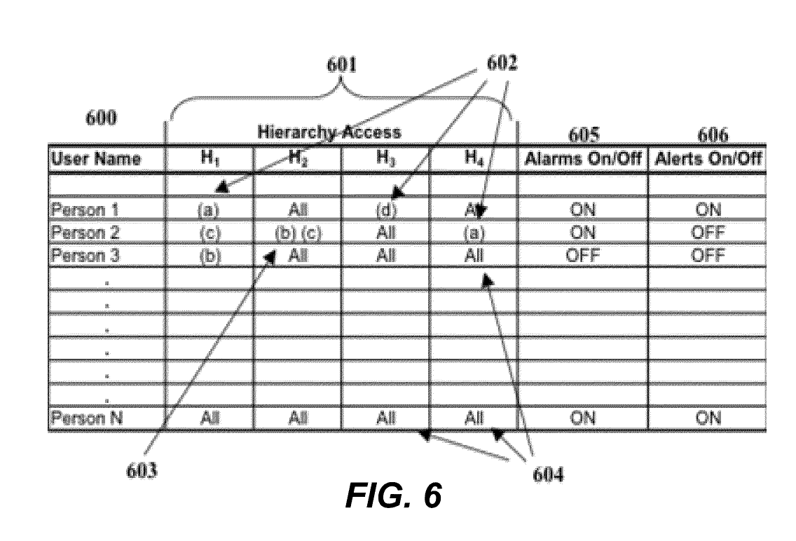

While the above example illustrates the hierarchy structure being populated with “hardware” or device related features, it is also possible to use the hierarchies to associate individuals with the device(s) (e.g., device locations, device functions, etc.) or any other hierarchical characterization of the devices, or with events such as alarms and alerts associated with monitored conditions. For example, FIG. 6 shows a personnel-based hierarchy structure with alarms and access controls. With personnel associations, a particular user can be associated with a hierarchy structure defined for a particular geography and function. The same user can be associated with a different hierarchy that is associated with emergency response, independent of the first hierarchy. For example, with H1, H2, H3, and H4 defined, a second (J1, J2, J3, J4), third, or multiple set of hierarchies can be built, that describe a completely independent hierarchical structure on the same users. These hierarchy sets can include line management organization charts, training certifications, supervisory responsibilities, and other human resource structures, as non-limiting examples.

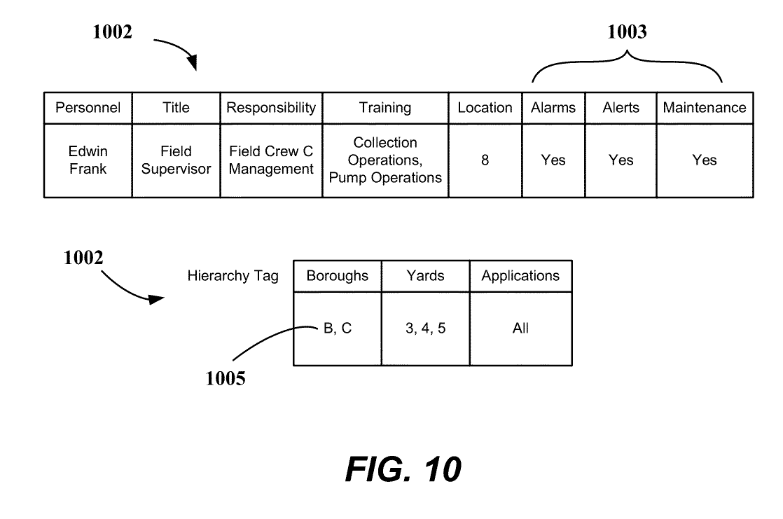

Using multiple hierarchies solves a problem with the use of strict hierarchies to cover parallel functions. Strict hierarchies flow with a single selection at each level, or a “wild card” at that level. If a designer needs to support the use of hierarchies that allow a subset of selections at a level, then multiple hierarchies can be used. FIG. 10 shows one example of a multiple hierarchy with two hierarchies 1001 and 1005. In the second hierarchy 1005, Edwin Frank is authorized to use Boroughs B and C, and by way of omission, not Boroughs A, D, or E (not shown). The “staff” hierarchy 1001 is crafted for Edwin Frank with Alarms, Alerts, Maintenance sets tagged as Yes. These hierarchies both can be used as selectors with “location hierarchy”.

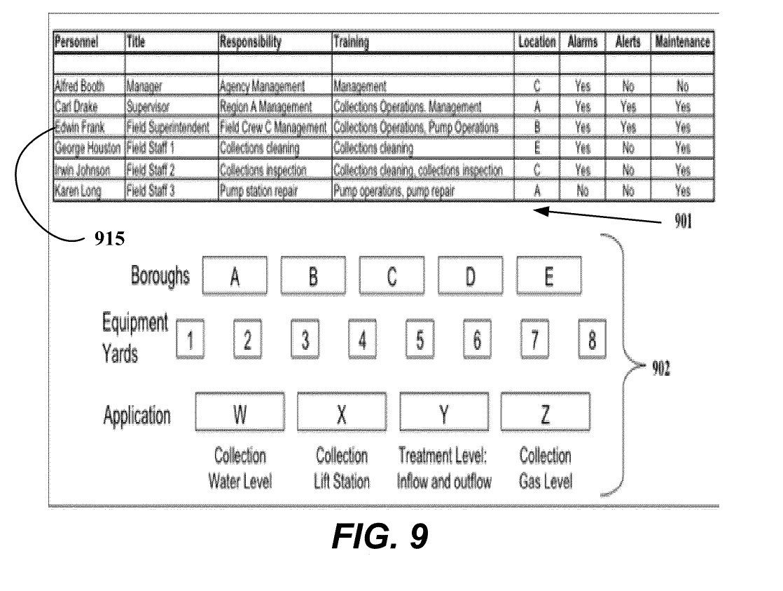

FIG. 9 shows an example of a multiple hierarchy structure with location hierarchy. With location hierarchy, there may be a single, strict hierarchy to define the parameters of a particular field unit. A hierarchy can be set up with device and location considerations, for example, given a RTU in wastewater manhole #571, defined in “Borough C”, serviced from “Equipment Yard 5”, with the Application set to “Collection Lift Station.” If Edwin Frank 915 was established in “Borough C”, Equipment Yard “5”, with a “wild card” for Application, then if an alarm condition occurred for manhole #571, he would receive notification of the alarm, be able to acknowledge them, and if so designed, see them on a web display.

Similarly the locations, or RTU sites can have multiple hierarchies defined. For example, the first hierarchy can be designed for physical response to alarms and service. The next hierarchy can be defined for financial purposes, such as capital or expense, funded by a particular grant, or cost shared with another agency, covering the same locations. Another example of the hierarchy is asset management, with master service organizations, installation history, master vendor association, and warranty data.

The multiple hierarchy structures can be used as mutual enable or disable masks for a wide range of management reporting, operations optimization, basic business functions, and planning

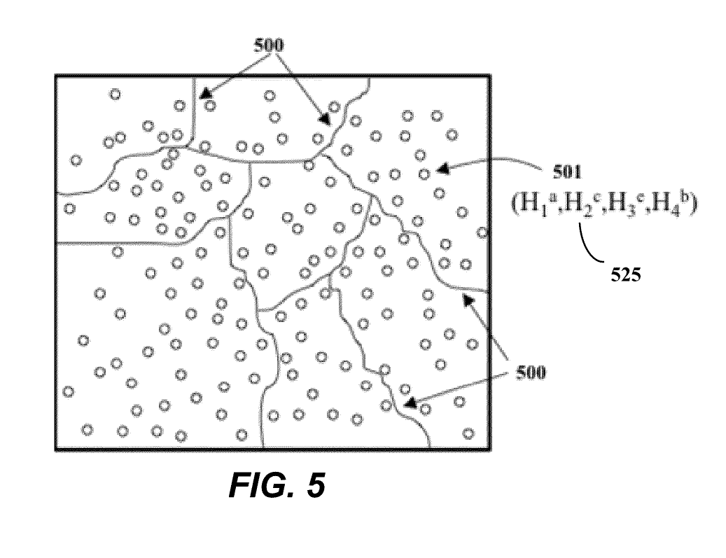

Each hierarchy scheme can be set up to divide the organization's remote monitoring locations in a manner that optimally fits the response requirements of the personnel in the organization. For example, FIG. 5 shows geographical divisions 500 of the physical layout of monitoring locations that corresponds to a staff member's assignment, responsibility, or residence location (in order to minimize response time to an alarm, for example). Other divisions, like those shown 401 in FIG. 4, naturally map to staff members' functions, responsibilities, or expertise. In FIG. 5, each monitoring location can be configured with an associated hierarchy tag 501 corresponding to the hierarchical definitions of that particular location. For example, as an illustration, in the case of a location 501 shown in FIG. 5, the hierarchy 525 associated with that location 501 can be set as:

H1 (line diameter) is less than or equal to 8 inches (“a” as the smallest size);

H2 (manhole depth) is greater than or equal to 20 feet (“c,” the largest depth);

H3 (geographic region) the fifth out of eight total regions (“e”); and

H4 (function) is lift stations (“b”, the other choice, for example, collection system locations).

In some embodiments, classification of a given location can be achieved with a user interface module, wherein the user provides that location with a hierarchy tag, with, for example, a pop-up window, or other standard user data input means. In addition, the user interface module can provide a way of tagging each organizational staff person with a user hierarchical tag that enables that person to have a specific set of access methods to the remote monitored data and system and a user-specific means to receive alarms, alerts or notifications from the remote field units.

FIG. 6 shows one possible example of a user interface, which would be displayed to a user. Various organizational staff personnel 600 are listed in the left hand column. The four available hierarchies 601 are shown as the next four columns. Each staff person's access to the data and reception of alarm, alert, or other notification data from the remote sides is shown in these columns. Options can be set to individual characteristics or multiple characteristics. For example, 602 represents individual characteristics (a), (d), (a) for given persons, while 603 represents multiple characteristics (b), (c) for a given person (e.g., Person 2). 604 represents the entire hierarchy (All). The option of sending alarms 605 or other alerts 606 such as maintenance or service issues are also a choice for each individual organizational staff person. The hierarchy access parameters for the users may also be used for notifications, and may form basic alert, or alarm, notification rules. That is, when an event occurs, the hierarchy access parameters may be used to identify individuals that should receive notification messages. The notification rules may include messaging parameters to be used for transmitting the notification messages, or alternatively, the messaging parameters may be associated with a user or employee data record according to a user ID parameter obtained from the notification rule.

While this example is meant to be illustrative it is not meant to be exhaustive of all possible variations of the described embodiments. Other aspects of an embodiment of the remote monitoring system requiring differential staff access, for example, physical access, or the ability to perform various analytical methods on the data, can be provided as part of the hierarchy, without limitation.

Example Application

The example discussed here is based on a wastewater utility. This example also extends to other types of utilities, for example a power utility, a drinking water utility, or other service oriented organizations (for example oil and gas companies) that can improve their operations through access to, and use of, real-time remote data.

The wastewater industry in particular is lacking in tools and technologies that can be used to automate many of their processes and communications. Large sanitation agencies in particular suffer from management problems associated with lack of real-time and integrated information from their wastewater system. Maintenance is done by schedule, not be need; capital projects are prioritized based on snapshots generated by spot checks; and spills are reported by citizens after they have occurred. Mainly the wastewater utilities are reactive rather than proactive, leading to vast inefficiencies, under-utilization of assets and personnel and sub-optimal operations. These deficiencies cost the utilities money and increase risks of overflows and treatment plant problems.

Consider a large wastewater utility that is currently operating without remote real-time monitoring. They may have one large centralized corporation yard where the field apparatus and rolling stock is housed. More often in large utilities, they are decentralized into small corporation yards where equipment is either the same or different than other yards. The geographies served by each yard may be distinct from each other, or there may be overlap. There may be arrangements between the yards for sharing equipment, either on a routine basis, or under emergency conditions. The personnel staffing these yards may be, for example, supervisors overseeing all yards, some yards, or only one yard. Some personnel may be on vacation and others may be sick, so there may be a need for personnel to move assignments from one yard to another. Lower level field personnel may only be assigned to a single yard, for example. In addition, personnel may have specific assignments or expertise. Some may be pump mechanics, others may be cleaning crews. In a wastewater system, there can be multiple applications or uses of remote real-time monitoring, including without limitation collection system manhole monitoring, lift/pump station monitoring, and treatment plant monitoring.

Data, measurements, and analysis provided by a widely dispersed sensing system that operates through a single or multiple central servers needs to be intelligently dispersed to the locations and personnel in order to make the best and most appropriate management decisions. The method described herein, details how this data is dispersed though a structured hierarchy in order to provide the most current, accurate and relevant decisionable data for a manager or supervisor. Consider the present example, an organization can be broken into the following sets:

Personnel

Corporation Yards

Geographies

Applications

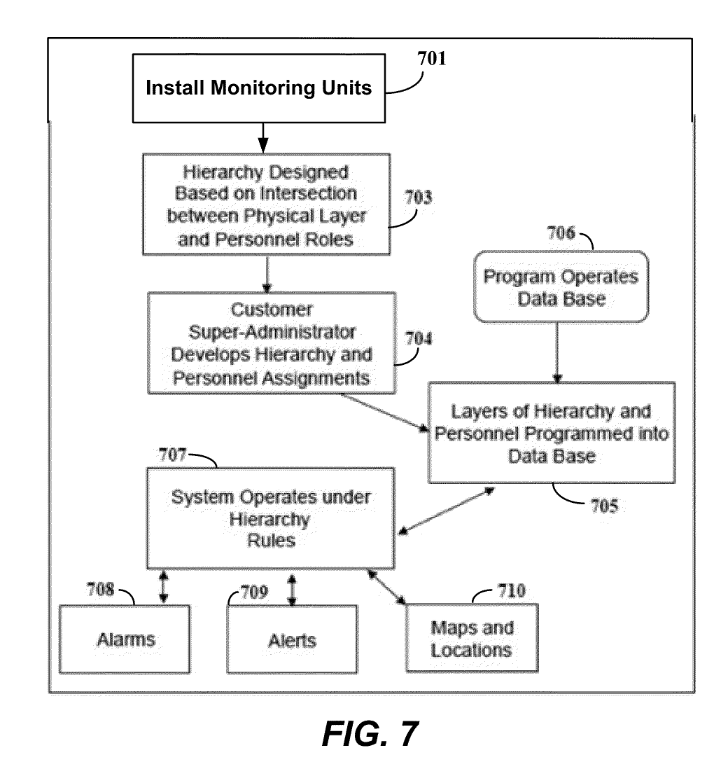

FIG. 7 is a flow chart of one embodiment of implementing the disclosed hierarchy system, as part of management analysis for a wastewater organization. Of course, the processes in FIG. 7 may be applied to other scenarios and therefore is understood to not be limited to a wastewater organization.

The hierarchal system may be initially established by a user (e.g., municipality) installing monitoring units 701 that monitor, for example, water level in the wastewater sewer collection system, pressure of pumps or pressurized pipes in a sewer collection system, water flow in for example gallons per minute in portions of the sewer collection system, water quality for example pH, dissolved oxygen, temperature, biochemical oxygen demand, say water level monitoring or gases such as hydrogen sulfide, chlorine, or methane at various points in the sewer system, all of the former suggested as examples without limitation.

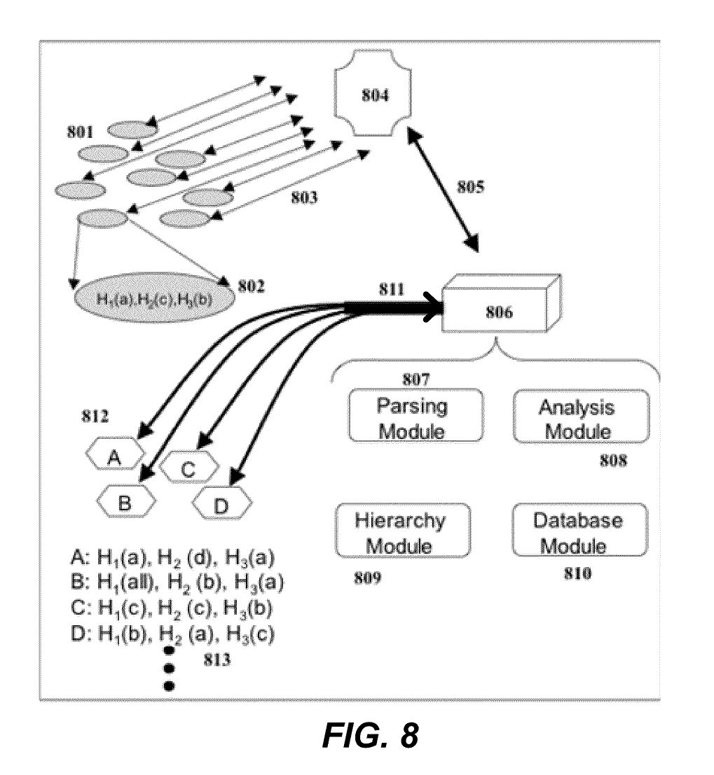

Based on the size of the user's system and the complexity of operations, a user may configure a hierarchy 703 for use by the “operator” (e.g., wastewater branch of municipality) of the remote monitoring system. The hierarchy 703 may be based on the types of personnel who will be interacting with the system. For example, these could be system supervisors, field superintendents, and various levels of field staff who have differing levels of responsibility and expertise. A sample design is shown in FIG. 9, showing the personnel's information 901 and physical attributes 902 for a fictional but typical wastewater utility. Given the personnel specific attributes (management level, role and responsibility, training, location, etc.) as seen in, for example, FIG. 9 and the different types of monitoring applications in the wastewater system, an administrator or super-administrator, or someone with assignment authority, assigns 704 a hierarchy tag to each location or set of locations of the installed monitoring units, that uniquely identifies the location based on location name and hierarchy attributes such as borough, proximity to a corporation yard, and application. An example of such a hierarchy assignment process can be seen in FIG. 8,s set of locations 801 and assigned hierarchy 802. The “administrator” can also further assign 704 a second (or third, etc.) hierarchy tag and notification tag to designated personnel or staff member using, for example, a web-based graphical interface. An example of this sub-level hierarchy assignment is seen as 813 in FIG. 8. Another more specific example can be seen in FIG. 10, which shows the secondary hierarchy tag 1002 associated with the staff member 1001 Edwin Frank, Field Superintendent. The notification tag 1003 is also shown.

Returning to FIG. 7, after assignment of the location hierarchy tag and the personnel hierarchy tag (704), they are stored in a server hierarchy database 705 managed by software 706. Next, with a populated server hierarchy database 705, the user system operates 707 under hierarchy rules, with data, assignments, hierarchy information, etc. being polled from server hierarchy database 705, as needed. As alarms 708, alerts 709, etc. are triggered, the respective hierarchical person assigned in the server hierarchy database 705 would notified, according to the hierarchy rules. Additional programs or user-assisting modules could link into the user system 707, to provide additional features. For example, upon an alarm 708 or alert 709, a map interface 710 displaying the locations responsible for the alarm 708 or alert 709 could “pop-up” on the user's device. Various elements of the map interface 710, alarms 708, alerts 709, and so forth, would be subject to the server hierarchy database 705 and associated server software 706.

FIG. 8 is an illustration showing one non-limiting example of the hierarchy system in operation. A plurality of sensing locations 801 present measurement data information from remote sensors, using various sensor types such as water level sensors, flow sensors, gas sensors, pressure sensors, water quality sensors, and other sensors including but not limited to traffic sensors, weather sensors, seismic sensors, air quality sensors, liquid level sensors, acoustic sensors, and other environmental sensors, etc.

Picking a particular site 802 out of these locations 801, a blow-up shows that this site 802 has a hierarchy tag of H1(a), meaning this location is in the first borough, H2(c), meaning this location is served by the third corporation yard, and H3(b), meaning this location is a collection system lift station. Located at this site 802 is a sensor sensing parameters at a lift station that may include as examples, without limitation, water level, flow in and out of the lift station, water quality, gas such as hydrogen sulfide, chlorine or methane inside and outside the lift station wet well, pump operating parameters such as current and voltage, other electrical and mechanical parameters. The sensor, or RFU, at this location 802 may simply collect data and send this data via wireless channel 803 to a data transceiver 804, or the sensor may be a “smart” sensor that has a self-contained or connected central processing unit (CPU) and other supporting electronics. This “smart” sensor takes readings on-site; performs on-site analysis of the data to provide higher data integrity, for example, without limitation, by making multiple measurements and using the mean or median of these measurements as the reported measurement; makes decisions based on the data collected if the data is acceptable or not and re-measures until a good measurement is made; determines if a measurement exceeds a threshold in order to determine if an alarm or alert should be transmitted through wireless channel 803 in order to minimize transmissions and power consumption; or performs other functions in order to minimize power consumption, increase data integrity, decrease the false positive rate; or verify that the measurement is of high enough integrity to report. Power is minimized in that many measurements that may not take much power may be made without the need to report through wireless means, which is typically the most power intensive activity performed by the remote sensing location.

All of the remotely monitored sites 801 report through the wireless channel 803 which may be via cell phone, two-way pager, dedicated radio, satellite, or other wireless communications service or device. This wireless channel 803 may be fully two-way such that commands may be sent to the remote sensor to, for example without limitation, turn the sensor off, change threshold parameters, or reprogram the sensor. Wireless channel 803 sends data from remotely monitored sites 801 to a remote data transceiver 804 such as a terrestrial cell phone, pager or dedicated radio base station or a space based transceiver such as, without limitation, a low-earth-orbit satellite or geosynchronous satellite. Data moves back and forth through the remote data transceiver 804 to a ground based connection 805, which may be satellite receiver connection. Once this data is received at the ground based connection 805, it is sent to server 806 upon which resides various codes that operate as modules and control the analysis, communications, and storage of the data collected from the remote monitoring sites 801. Alternatively, the data may be sent directly from the remote data transceiver 804 to the server 806 via the Internet or other equivalent networks.

Also residing on the server 806 is a set of operating software code that together with the programed hardware comprises a plurality of modules: the parsing module 807, the analysis module 808, and the hierarchy module 809. These may be separate operating software code sections/modules or may be portions of a single integrated code/module. The data base module 810 identifies the remotely monitored locations along with their hierarchy tags. Each module 807, 808, 809 interacts with this database module 810, making changes as needed, or pulling out data for analysis. The analysis module 808 performs analysis on data transmitted as requested by a hierarchical user 812 and stored on server 806. Results of this data analysis are routed by the hierarchy module 809 to the hierarchically designated users 812 for display or alarm or alert. The parsing module 807 acts as the gatekeeper in cases where there may be multiple separate organizations using the system, and determines where data from the remote sites should go, and to where commands from users 812 should be sent. In addition, an indicator may be sent by a user 812 to the analysis module 808, for example, prompting some analysis to take place such that a result needs to be either sent back to that location 801 or another location (e.g., nearby manhole), or to a hierarchical user 812 of the system. The hierarchy module 809 routes the data and analysis requests, input and output—from users 812 with hierarchy tags 813 to the associated locations 801 with associated hierarchical tags, in this instance, 802.

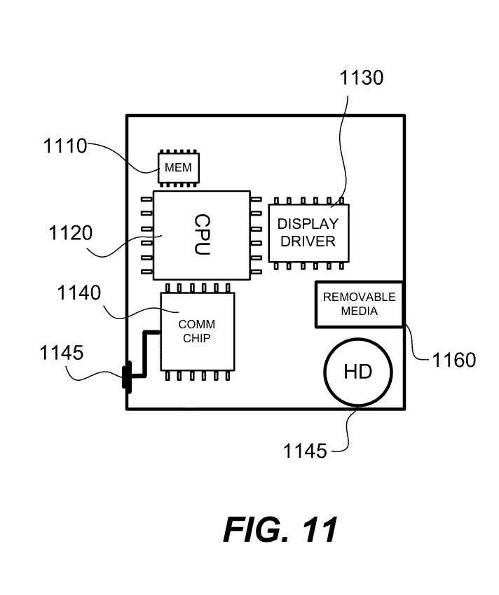

FIG. 11 is an illustration of computer hardware, typically found in a server or user handheld communications device (mobile phone, smartphone, tablet, etc.), or even a transceiver. Recognizing the hardware differentiation between a server and handheld device being more indistinguishable each day, it is understood that a server is a powerful computer with one or more processors 1120 and an assortment of memory peripherals such as solid state memory 1110, hard drive 1145, removable memory/media 1160, which may be on board or off board, depending on configuration. Removable memory/media can have many different forms, such as USB, floppy disc, CD, etc. Processor 1120 will typically interface a display (not shown) via a display driver 1130 and communicate externally via a communication chip 1140 via external bus 1145. If a wireless connection is used, communication chip 1140 may have transceiver capabilities and bus 1145 may be terminated by an antenna.

The various software modules and processes described herein can be programmed and stored either in memory 1110, removable memory/media 1160 or hard drive 1145 (noting that optical drives, tape drives can also proxy hard drive 1145). The stored instructions are executed by processor 1120 and information regarding the hierarchal/notifications/assignments/, etc. can be externally communicated by communications chip 1145. The illustration of FIG. 11 is known to be a simplification, however, one of ordinary skill in the art would understand what modifications and changes can be made to the computer hardware to enable the various processes to function.

Given the hierarchal method(s) and system(s) described above, a sample scenario is described below where a large number of monitoring devices are deployed in a large city with either a significant geography or large population. In this scenario, devices that measure water levels in the collection system, water levels in wet wells in the collection system, pressure in force mains, and hydrogen sulfide gas are all deployed throughout the wastewater collection system.

Under normal (non-alarm and non-alert) conditions, the remote “smart” sensors periodically measure water level or pressure or gas concentration, respectively, process the measurements locally as described elsewhere in this disclosure, store the measurements, and on another periodic basis, send this data back through the wireless communications system to the central server. The hierarchical scheme described herein then disperses this data, possibly in the form of alters, alarms, or simply data visualization display devices, based on the hierarchical tags of both the remote monitoring locations and the user personnel, so that the appropriate personnel are viewing the data that they are both interested in and responsible for.

In some embodiments, the system includes an event rules database for storing event rule definitions. Event rules may specify the characteristics of a particular event, which may include maintenance alert rules, alarm rules, or other event rules, such as alarms of different levels (major alarms, failure alarms) and the like. The event rules may be established for individual monitoring devices such as when a water level exceeds a threshold, or a pressure level surpasses a threshold. Event rules may also be established that include measurements from combinations of monitoring devices at one or more monitoring locations. Further embodiments may include notification rules that specify (or may be used to obtain) notification messaging parameters for various events, alarms, or alerts. That is, in one embodiment, the hierarchical parameter values assigned to a given individual may be used to identify the recipient of notifications (e.g., alarms, alerts, or other event occurrences).

Thus, in one embodiment, a method may comprise, receiving measurement data from a remote monitoring device; determining the occurrence of an event based on the received measurement data and one or more event rules; obtaining a plurality of monitoring device hierarchy parameters associated with the remote monitoring device from a data storage device; and determining notification data based on at least one of plurality of monitoring device hierarchy parameters. In some embodiments, the function of determining notification data may comprise, querying a notification rule set to identify at least one messaging address.

The method may also further comprise, transmitting an event notification message to the at least one messaging address. In some embodiments the event notification rule set may comprise, a plurality of notification rules, each notification rule having an event type, at least one messaging address, and one or more notification hierarchy parameters, such as the parameters 813. The results of the query identifies notification rules having notification hierarchy parameters that match at least a subset of the plurality of monitoring device hierarchy parameters.

The disclosed hierarchy method(s) and system(s) can be extraordinarily relevant to the wastewater industry and more generally to large utilities or service organizations. In terms of wastewater collection risks, for a large rainfall event, sanitary sewer overflows (SSOs) or combined sewer overflows (CSOs) are the single most important incident to avoid for wastewater agencies. Consequences being, sewage enters the environment creating general health hazards; regulating agencies can fine the utility; homeowners can sue the utility for property damage; there are cleanup and mitigation costs; and bad press creates political problems for the agency. Rainfall events typically stress wastewater collection systems because of an effect called inflow and infiltration (“I and I”). During a rain event, runoff water can enter the collection system directly through manhole covers or other openings in the system (inflow) or over time, as the ground water levels increase, ground water elevated by rains can enter the collection system through cracks and gaps in pipelines and manholes and other underground structures (infiltration). SSOs and CSOs will occur because: (a) the pipeline capacity is insufficient to handle the flow of water in the pipeline; (b) grit, grease, or other natural or man-made obstructions will block water flow in the line; or (c) old or damaged pipelines will partially or fully collapse creating a blockage.

Rainfall occurs, and alarms and alerts are generated at locations that have unusual flows, based on their water level patterns, or exceed water level thresholds. These water level patterns that are different than normal from one or more of a given set of locations in a particular hierarchy signify where problems are, either starting (alerts) or getting close to occurring (alarms). These alarms and alerts are sent to the proper staff personnel also identified by their hierarchy. Thus, the system acts as an automatic and intelligent dispatcher, providing an immediate and appropriate response to a stress on the utility system. No such system or capability is yet available, therefore this solution is a new and innovative means to prevent or minimize disasters that can occur with utilities or organizations that have widely dispersed and varied assets.

The embodiments detailed herein are described in the context of a particular application and therefore not meant to limit the invention to, for example, wastewater utility operations. Similar examples can be drawn up for, without limitation, other organizations or utilities that need to integrate or fuse data from multiple hierarchical remotely monitored locations and have a need to analyze large amount of disparate data and also provide rapid and appropriate response to emergencies and to avoid expensive or environmental disasters, such as drinking water utilities, electrical utilities, oil and gas utilities, environmental monitoring organizations such as USGS, the USEPA, and other large organizations with need for large scale remote monitoring.

In some embodiments, Alerts and Alarms (see FIG. 7's 708 and 709, for example) are originated in a similar manner—a message is sent by the server through a wireless channel or the Internet to a user who needs to take action based on the content and seriousness of the message. Alerts can be, for example, lower level maintenance alarms, informing the user that something is not operating properly at the monitoring location, for example, a low battery, a malfunctioning sensor, or a communications problem. Alerts may indicate a need for action, but not immediately. An Alarm is an indication to the properly notified person—defined through the hierarchy—that there is a serious problem worthy of immediate attention by that person, either a dispatch of the proper equipment, other personnel or an acknowledgement that the Alarm was received.

In further embodiments, the system may include a data analytics modeling module to identify trends in data using one or more of a number of well-known data mining and statistical techniques, including regression analysis, cluster analysis, analysis of variance and multivariate analysis of variance, nonparametric analysis, survival analysis, categorical data analysis, Bayesian analysis, stochastic gradient boosting algorithms, matching filtering, and iterative decision tree analysis. Well-known software packages that may be used to identify relationships among the data and to generate event rules include SAS Institute's STAT software, Salford Systems TreeNet data mining tool, IBM's SPSS Modeler, and many others. The system may identify patterns of various levels, as follows:

Level 1, Individual location pattern recognition: remote sensor measurements have “typical” patterns. In the case of water level, for example, the water level in a sewer typically peaks two times per day, late morning and early evening. Water levels at lift stations are a function of pumps going on and off. Deviations from these standard levels, for example, can be captured using pattern recognition techniques, high pass and low pass filters, matched filters, or simple statistics such as mean, median, standard deviation, and skew. A Sewer Intelligence® Alert (SIA) would be generated for a single location based on a deviation from normal. The user would be able to “dial in” how much deviation they want before such a SIA is generated, and also which pattern recognition tools they'd want to use to match the particular change they'd be expecting, or have seen based on historical water levels recorded and stored by the system under circumstances about which they'd want to be alerted. A customizable tool that would allow the user to choose their own pattern recognition on which to Alert would also be available.

Level 2, Patterns seen among a group of locations: a second level of Alerts would be generated by comparing the time and location correlations of sensor measurements amongst a group of locations. Sensors deployed in an array with sufficient density can monitor various parts of the system and show events as they move through the system and also capture events that affect a group of sensors simultaneously. Similar pattern recognition tools can be deployed, including time and space series and filters or matched filters that provide a means to correlate nearby or physically connected portions of the system. Simple examples would be the overall mean level of water in a group of sensors as a function of time, signifying a snapshot of the storage capacity in that region of the sewer collection system, or a high water level wave that passes though the collection system due to an external disturbance such as a dumping event or rainfall event in either a dispersive (spreading out) or non-dispersive (solitary wave behavior) manner.

Level 3, Patterns seen amongst a single or group of locations and different sensors at the same or nearby locations. If more than one type of sensor were used, for example, level sensors and gas sensors, there can be correlations between these sensors that suggest an event or impending event. Hydrogen sulfide gas may build up in a collection system because of lack of flow due to a backup or clog in a pipeline, at the same time water levels may increase or decrease in response to this backup elsewhere in the collection system. Another example would be rain sensors that correlate the increase in water levels in a sewer collection system in time, rainfall intensity (for example inches per hour as a function of time), and location within the system. This type of information, for example, would provide a means for a system operator to gauge the severity of I and I problems as well as the locations of the occurrence of I and I.

The foregoing is illustrative only and is not intended to be in any way limiting. Reference is made to the accompanying drawings, which form a part hereof. In the drawings, similar symbols typically identify similar components, unless context dictates otherwise.

Note that the functional blocks, methods, devices and systems described in the present disclosure may be integrated or divided into different combinations of systems, devices, and functional blocks, as would be known to those skilled in the art.

In general, it should be understood that the circuits described herein may be implemented in hardware using integrated circuit development technologies, or via some other methods, or the combination of hardware and software objects could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, implementations, and realizations, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those skilled in the art that, in general, terms used herein, and especially in the appended claims (e.g., bodies of the appended claims) are generally intended as “open” terms (e.g., the term “including” should be interpreted as “including but not limited to”, the term “having” should be interpreted as “having at least”, the term “includes” should be interpreted as “includes but is not limited to”, etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
electronically receiving device data transmitted from a remote measurement device;
determining an occurrence of an event based on the received device data and one or more event rules;
obtaining a plurality of remote measurement device parameters associated with the remote measurement device from a database containing a hierarchy of rule sets matching personnel data with remote measurement devices, physical resource data, notification states and access controls;
querying the hierarchy for at least one or more persons assigned to the remote measurement device or to a geographical proxy thereof and also having a notification state corresponding to the event;
electronically notifying information of the event to a communication device of the identified one or more persons; and
responding to an input from the assigned person via the communication device to provide at least one of the remote measurement device location and access control.

2. The method of claim 1, further comprising creating a hierarchy of rule sets matching personnel data with remote measurement devices, physical resource data, notification states and access controls, and installing the hierarchy in a database stored on a server.

3. The method of claim 1, wherein notifying comprises querying a notification rule set to identify at least one messaging address of the at least one or more persons.

4. The method of claim 3, wherein the notification rule set comprises a plurality of notification rules, each notification rule having an event type, at least one messaging personnel address, and one or more notification hierarchy parameters.

5. The method of claim 4, wherein the querying identifies notification rules having notification hierarchy parameters that match at least a subset of the plurality of remote measurement device parameters.

6. The method of claim 1, wherein the hierarchy is comprised of multiple hierarchies.

7. The method of claim 6, wherein the multiple hierarchies comprise at least one of a hierarchy for physical response to alarms and service, emergency response, capital or expense, cost shared with another agency, asset management, installation history, master vendor association, and warranty data.

8. The method of claim 6, wherein the multiple hierarchies comprise hierarchy sets of line diameter sizes, manhole depths, geographic regions, and functions.

9. The method of claim 1, wherein the database is stored on a server, the server electronically receiving the device data transmitted from the remote measurement device.

10. The method of claim 1, wherein the hierarchy further comprises a parsing module, an analysis module, and a database module.

11. The method of claim 1, wherein the notification state is at least one of an alarm state and an alert state.

12. The method of claim 1, wherein the device data is transmitted over a satellite connection.

13. The method of claim 1, wherein the electronically notifying is performed over at least a cellular network and Internet network.

14. The method of claim 1, wherein the remote measurement device is positioned in a manhole.

15. The method of claim 1, wherein the remote measurement device is part of at least one of an environmental monitoring system and a utility monitoring system.

16. The method of claim 15, wherein the utility monitoring system is a sewer monitoring system that monitors at least water level or flow of a fluid.

17. The method of claim 1, wherein access control enables the assigned person to have turn a system control on or off.

18. The method of claim 6, wherein the multiple hierarchies are defined for each user of a monitored system or each location in the monitored system.

19. A remote measurement device management and notification system, comprising:
means for electronically receiving device data transmitted from a remote measurement device;
means for determining an occurrence of an event based on the received device data and one or more event rules;
means for obtaining a plurality of remote measurement device parameters associated with the remote measurement device from a database containing a hierarchy of rule sets matching personnel data with remote measurement devices, physical resource data, notification states and access controls;
means for querying the hierarchy for at least one or more persons assigned to the remote measurement device or to a geographical proxy thereof and also having a notification state corresponding to the event;
means for electronically notifying information of the event to a communication device of the identified one or more persons; and
means for responding to an input from the assigned person via the communication device to provide at least one of the remote measurement device location and access control.

20. A tangible computer-readable storage medium having instructions stored thereon that when executed by a processor cause the processor to:
determine an occurrence of an event based on received device data and one or more event rules;
obtain a plurality of remote measurement device parameters associated with the remote measurement device from a database containing a hierarchy of rule sets matching personnel data with remote measurement devices, physical resource data, notification states and access controls;
query the hierarchy for at least one or more persons assigned to the remote measurement device or to a geographical proxy thereof and also having a notification state corresponding to the event;
electronically notify information of the event to a communication device of the identified one or more persons; and
respond to an input from the assigned person via the communication device to provide at least one of the remote measurement device location and access control.
